(19) United States
(12) Patent Application Publication
(10) Pub. No.: US 2006/0124028 A1
(43) Pub. Date: Jun. 15, 2006

(54) Inkjet ink compositions comprising carbon nanotubes

(76) Inventors: Xueying Huang, Hockessin, DE (US); Gann Xu, Boothwyn, PA (US); Nicole M. Reinartz, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/298,968

(22) Filed: Dec. 9, 2005

Related U.S. Application Data
(60) Provisional application No. 60/634,566, filed on Dec. 9, 2004.

(51) Int. Cl. C09D 11/00

(52) U.S. Cl. 106/31.92

(57) ABSTRACT

The invention provides new ink jet ink compositions comprising chemically functionalized or physically modified, singly dispersed carbon nanotubes. The ink jet ink compositions are suitable for use in conventional ink jet printing and may be used in printing applications on paper or textile fabrics, or to prepare conductive or semiconductive patterns of carbon nanotubes for electronic applications.

### CROSS-REFERENCE TO RELATED APPLICATIONS

This application claims priority under 35 U.S.C. §119 from U.S. Provisional Application Ser. No. 60/634,566 (filed Dec. 9, 2004), the disclosure of which is incorporated by reference herein for all purposes as if fully set forth.

### FIELD OF INVENTION

The invention relates to the field of ink jet printing. More specifically, the invention relates to ink jet ink compositions comprising chemically functionalized or physically modified, singly dispersed carbon nanotubes.

### BACKGROUND OF THE INVENTION

Ink jet printing is a non-impact method for recording information in response to an electronic signal, such as that generated by a computer. The electronic signal causes the ink jet printhead to produce droplets of ink and deposit the droplets on a print media, such as paper or transparent film. Ink jet printers have found wide acceptance, particularly in the office printer market, because of their relatively low cost, reliability, print quality and relatively quiet operation. Additionally, ink jet printing may be used to form a pattern on a substrate for use in electronic and coating applications. Ink jet printing can be especially advantageous for making unique prints or small lots because, as a digital technology, images can be easily changed or varied.

Carbon nanotubes (CNT) have been the subject of intense research since their discovery in 1991. Carbon nanotubes possess unique properties such as small size, considerable stiffness, and electrical conductivity or semiconducting behavior, which make them suitable in a wide range of applications. Carbon nanotubes may be either multi-walled (MWNT) or single-walled (SWNT), and have diameters in the nanometer range.

U.S. Pat. No. 6,758,891 describes a carbon-containing material with organic groups, which is obtainable by reaction of a carbon-containing compound, such as carbon black, graphite powder, graphite fibers, carbon fibers, carbon fibrils, carbon nanotubes, carbon fabrics, glass-like carbon products and active carbon, with a triazole compound. In that disclosure it is suggested that the carbon-containing material with organic groups may be used as a pigment in printing inks, inks and ink jet inks.

The use of carbon nanotubes to make conductive films for electronic applications is known. For example, US2003/0122111 describes an electrically conductive film containing a plurality of single-walled carbon nanotubes. US2004/0099438 describes a two-step method for patterning a carbon nanotube film comprising applying a solution of carbon nanotubes to a substrate and impregnating the carbon nanotube film with a binder or photoresist. US2004/0102044 describes a method for incorporating low work function metals and their salts into carbon nanotubes for use as field emission devices. U.S. Pat. No. 6,330,939 describes an ink comprising carbon nanotubes that is used to determine the authenticity of documents.

All of the above-identified disclosures are incorporated by reference herein for all purposes as if fully set forth.

In all of the aforementioned disclosures, the length of the carbon nanotubes described is not well suited for use in conventional ink jet printers. Specifically, the carbon nanotube dispersions contain nanotubes having a size distribution with lengths as large as 7 μm up to 20 μm. Additionally, none of the disclosures describe a composition having physical properties (i.e., surface tension and viscosity) suitable for ink jet printing.

Therefore, the need exists for an ink jet ink composition comprising carbon nanotubes that is suitable for printing with conventional ink jet printers.

Applicants have met the stated need by providing ink jet ink compositions comprising chemically functionalized or physically modified, singly dispersed carbon nanotubes, having a length suitable for ink jet printing.

### SUMMARY OF THE INVENTION

The invention relates to the use of singly dispersed carbon nanotubes in ink jet printing applications. The carbon nanotubes of the invention may be chemically functionalized or physically modified to provide a dispersion having a size distribution that is suitable for ink jet printing.

The invention provides an ink jet ink composition comprising:

(a) an aqueous carrier medium suitable for ink jet printing; and

(b) chemically functionalized and singly dispersed carbon nanotubes, wherein the carbon nanotubes have an average outer diameter of less than or equal to about 10 nanometers and a length between about 100 nanometers and about 1 micrometer.

In another embodiment, the invention provides an ink jet ink composition comprising:

(a) an aqueous carrier medium suitable for ink jet printing; and

(b) physically modified and singly dispersed carbon nanotubes, wherein the carbon nanotubes have an average outer diameter of less than or equal to about 10 nanometers and a length between about 100 nanometers and about 1 micrometer.

The invention also provides a method of producing an ink jet ink composition comprising chemically functionalized and singly dispersed carbon nanotubes, comprising the steps of:

(a) providing a population of undispersed carbon nanotubes in solution;

(b) contacting the carbon nanotubes of (a) with a radical generating agent in the presence of acid for a time sufficient to permit the carbon nanotubes to disperse; and

(c) mixing the dispersed carbon nanotubes of (b) with an aqueous carrier medium suitable for ink jet printing.

In another embodiment, the invention provides a method of producing a carbon nanotube pattern on a substrate comprising the steps of:

(a) providing an ink jet ink composition comprising an aqueous carrier medium suitable for ink jet printing and chemically functionalized and singly dispersed carbon nanotubes, wherein the carbon nanotubes have a mean outer diameter of less than or equal to about 10 nanometers and a length between about 100 nanometers and about 1 micrometers;

(b) printing a pattern of the ink jet ink composition of (a) on the substrate using an ink jet printer, and

(c) drying the ink jet ink composition on the substrate of (b) to form the carbon nanotube pattern.

In another embodiment the invention provides a method of producing a carbon nanotube pattern on a substrate comprising the steps of:

(a) providing an ink jet ink composition comprising an aqueous carrier medium suitable for ink jet printing and physically modified and singly dispersed carbon nanotubes, wherein the carbon nanotubes have a mean outer diameter of less than or equal to about 10 nanometers and a length between about 100 nanometers and about 1 micrometer;

(b) printing a pattern of the ink jet ink composition of (a) on the substrate using an ink jet printer, and

(c) drying the ink jet ink composition on the substrate of (b) to form the carbon nanotube pattern.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### BRIEF DESCRIPTION OF THE FIGURES AND SEQUENCE DESCRIPTIONS

The invention can be more fully understood from the following detailed description, figures and the accompanying sequence descriptions, which form a part of this application.

FIG. 1 is a schematic illustration of chemically functionalizing carbon nanotubes.

FIG. 2 is a schematic diagram of the system used to measure the conductivity of a carbon nanotube film on a silicon substrate, as described in Example 5. “CNT” refers to the carbon nanotube film.

The following sequences conform with 37 C.F.R. 1.821-1.825 (“Requirements for Patent Applications Containing Nucleotide Sequences and/or Amino Acid Sequence Disclosures—the Sequence Rules”) and consistent with World Intellectual Property Organization (WIPO) Standard ST.25 (1998) and the sequence listing requirements of the EPO and PCT (Rules 5.2 and 49.5(a-bis), and Section 208 and Annex C of the Administrative Instructions). The symbols and format used for nucleotide and amino acid sequence data comply with the rules set forth in 37 C.F.R. §1.822.

SEQ ID NO:1 is the nucleotide sequence of the oligonucleotide (C/T)30 used in Example 3.

### DETAILED DESCRIPTION OF THE PREFERRED EMBODIMENTS

The invention provides ink jet ink compositions comprising chemically functionalized or physically modified, singly dispersed carbon nanotubes. The compositions contain carbon nanotubes having a size distribution that is suitable for ink jet printing applications. Additionally, the compositions have the required surface tension and viscosity for ink jet printing.

The invention is useful because the ink jet ink compositions may be used for conventional printing applications on paper or textile fabrics, wherein the carbon nanotubes serve as a black pigment. The increased surface area of the carbon nanotubes compared to typical pigments may provide an enhanced interaction with the print medium, resulting in increased durability. Additionally, the ink jet ink compositions may be useful for forming a carbon nanotube pattern on a substrate for use in electronic and coating applications. For example, patterned carbon nanotube films may be used as electrical interconnects, electrodes, and wires; in thin film transistors, inductors, capacitors, and resistors; for all types of displays including electroluminescent displays and “electronic paper” displays on flexible substrates; as anti-static coatings; in solar cells; in chemical, biological, or mechanical sensors; and as conductive or semiconducting films on papers, plastics, and textiles. The pattern may be either conductive or semiconductive, depending on the type of carbon nanotubes used.

The following definitions are used herein and should be referred to for interpretation of the claims and the specification.

“CNT” means carbon nanotube(s).

“MWNT” means multi-walled nanotube(s).

“SWNT” means single-walled nanotube(s).

The term “singly dispersed carbon nanotubes” refers to a population of carbon nanotubes that is substantially completely dispersed. Specifically, each nanotube fiber is substantially separated from the others and is not part of a “bundle”. They are separate entities and are free of strong interaction from each other. The nanotubes are also substantially uniformly distributed throughout the medium. Dispersion can be shown-by absorption measurements, as described in US2004/0132072 and by Bachilo et al., Science 298:2361 (2002) (the disclosures of which are incorporated by reference herein for all purposes as if fully set forth).

The term “chemically functionalized carbon nanotubes” refers to carbon nanotubes that have been chemically treated to introduce functional groups on the surface. Chemical treatments include, but are not limited to, oxidation, radical initiation reactions, and Diels-Alder reactions.

The term “physically modified carbon nanotubes” refers to carbon nanotubes that have been dispersed by physical means, for example, ultrasonication, or have been coated with or are associated with a modifying agent.

The term “modifying agent” refers to reagents used to coat carbon nanotubes to disperse them in aqueous solution. Modifying agents include, but are not limited to, surfactants, such as sodium dodecylsulfate, alkyl benzene sulfonate, dextrin, polyethylene oxide, alkyl-ether sulfonate and Triton® series compounds (Dow Chemical); organic polymers, such as polyamines, anionic polymers, cationic polymers, polyvinylpyrrolidone, polysaccharides, gum arabic, polystyrene sulfonate; and biopolymers, such as peptides, proteins and nucleic acids.

As used herein a “nucleic acid molecule” is defined as a polymer of RNA, DNA, or peptide nucleic acid (PNA) that is single- or double-stranded, optionally containing synthetic, non-natural or altered nucleotide bases. A nucleic acid molecule in the form of a polymer of DNA may be comprised of one or more segments of cDNA, genomic DNA or synthetic DNA.

The letters “A”, “G”, “T”, “C” when referred to in the context of nucleic acids, represent the purine bases adenine (C₅H₅N₅) and guanine (C₅H₅N₅O) and the pyrimidine bases thymine (C₅H₆N₂O₂) and cytosine (C₄H₅N₃O), respectively.

The term “peptide nucleic acid” or “PNA” refers to an analogue of DNA that has a pseudo-peptide backbone, rather than the sugar-phosphate backbone of nucleic acids (DNA and RNA). PNA mimics the behavior of DNA and binds complementary nucleic acid strands.

All ranges given herein include the end of the ranges and also all the intermediate range points.

Carbon Nanotubes

The term “carbon nanotube” refers to a hollow article composed primarily of carbon atoms. The carbon nanotube can be doped with other elements, e.g., metals. The nanotubes typically have a narrow dimension (diameter) of about 1-200 nanometers and a long dimension (length), where the ratio of the long dimension to the narrow dimension, i.e., the aspect ratio, is at least 5. In general, the aspect ratio is between 10 and 2000. The carbon-based nanotubes of the invention can be either multi-walled nanotubes (MWNT) or single-walled nanotubes (SWNT). A MWNT, for example, includes several concentric nanotubes each having a different diameter. Thus, the smallest diameter tube is encapsulated by a larger diameter tube, which in turn is encapsulated by another larger diameter nanotube. A SWNT, on the other hand, includes only one nanotube.

Carbon nanotubes may be produced by a variety of methods, and are commercially available, for example from Carbon Nanotechnologies Inc. (Houston, Tex.) and Carbon Solutions Inc. (Riverside, Calif.). Methods of CNT synthesis include laser vaporization of graphite (Thess et al. Science 273, 483 (1996)), arc discharge (Journet et al., Nature 388, 756 (1997)) and HiPCo (high pressure carbon monoxide) process (Nikolaev et al. Chem. Phys. Lett. 313, 91-97 (1999)). Chemical vapor deposition (CVD) can also be used in producing carbon nanotubes (Kong et al. Chem. Phys. Lett. 292, 567-574 (1998); Kong et al. Nature 395, 878-879 (1998); Cassell et al. J. Phys. Chem. 103, 6484-6492 (1999); and Dai et al. J. Phys. Chem. 103, 11246-11255 (1999)).

Additionally CNTs may be grown via catalytic processes both in solution and on solid substrates (Yan Li et al., Chem. Mater. 13(3), 1008-1014 (2001); Franklin and Dai, Adv. Mater. 12, 890 (2000); and Cassell et al., J. Am. Chem. Soc. 121, 7975-7976 (1999)). Most CNTs, as presently prepared, are in the form of entangled tubes. Individual tubes in the product differ in diameter, chirality and number of walls. Moreover, long tubes show a strong tendency to aggregate into “ropes” held together by Van der Waals forces. These ropes are formed due to the large surface areas of nanotubes and can contain tens to hundreds of nanotubes in one rope.

Singly Dispersed Carbon Nanotubes

The carbon nanotubes of the invention are singly dispersed in order to provide the proper size distribution for ink jet printing. The singly dispersed carbon nanotubes have a diameter of less than or equal to about 10 nanometers and a length of about 100 nanometers to about 1 micrometer, with an average length of about 200 nanometers, and may be prepared in numerous ways. In one embodiment, the singly dispersed carbon nanotubes are prepared by physical modification using various means. In another embodiment, the singly dispersed carbon nanotubes are prepared by chemical modification.

Physically Modified Singly Dispersed Carbon Nanotubes

Carbon nanotubes may be physically modified by any means known in the art, including, but not limited to, ultrasonication or coating with a modifying agent. Suitable modifying agents include, but are not limited to, surfactants, such as sodium dodecylsulfate, alkyl benzene sulfonate, dextrin, polyethylene oxide, alkyl-ether sulfonate and Triton® series compounds; organic polymers, such as polyamines, anionic polymers, cationic polymers, polyvinylpyrrolidone, polysaccharides, gum arabic, polystyrene sulfonate; and biopolymers, such as peptides, proteins and nucleic acids. Many of these modification techniques are reviewed by Hilding et al. (Journal of Dispersion Science and Technology 24(1), 1-41 (2003)).

In one embodiment, carbon nanotubes may be physically modified by coating with biopolymers, such as peptides, proteins, and nucleic acids. A method for physically modifying carbon nanotubes using nucleic acids is described in copending and commonly owned US2004/0132072 and WO2004/048256, the disclosures of which are incorporated by reference herein for all purposes as if fully set forth. The nucleic acid molecules may be of any type and from any suitable source and include, but are not limited to, DNA, RNA and peptide nucleic acids. The nucleic acid molecules may be either single stranded or double stranded and may optionally be functionalized at any point with a variety of reactive groups, ligands or agents. The nucleic acid molecules of the invention may be generated by synthetic means or may be isolated from nature by protocols well known in the art (Sambrook, J., Fritsch, E. F. and Maniatis, T., Molecular Cloning: A Laboratory Manual, Second Edition, Cold Spring Harbor Laboratory Press, Cold Spring Harbor, N.Y. (1989)).

Where nucleic acids are used as a modifying agent it should be noted that no additional chemical functionalization of the carbon nanotube is necessary. Biopolymers generally have a native affinity for carbon nanotubes and the presence of additional functional groups on the surface of the carbon nanotube is not needed to effect good binding and dispersion.

Alternatively the carbon nanotubes of the invention may be modified using synthetic organic polymers. Methods for associating such polymers with carbon nanotubes are discussed by O'Connell et al., Chem. Phys. Lett., 342, 265 (2001); and WO02/076888, the disclosures of which are incorporated by reference herein for all purposes as if fully set forth.

Chemically Functionalized Singly Dispersed Carbon Nanotubes

Carbon nanotubes may be chemically functionalized using methods known in the art. The chemical functionalization of the carbon nanotube surface results in functional groups, including, but not limited to, —COOH, —PO₄⁻, —SO₃⁻, −SO₃H, —SH, —NH₂, tertiary amines, quaternized amines, —CHO and/or —OH.

The undispersed carbon nanotubes may be oxidized according to the methods described in US2003/0039604 and US2003/0086858, the disclosures of which are incorporated by reference herein for all purposes as if fully set forth. For example, the undispersed carbon nanotubes may be oxidized by contacting them with a radical generating agent, including, but not limited to, ammonium persulfate ((NH₄)₂S₂O₈), sodium persulfate (Na₂S₂O₈), or potassium persulfate (K₂S₂O₈) in an acid. Suitable acids include, but are not limited to, sulfuric acid, nitric acid, hydrochloric acid, or trifluoroacetic acid. This oxidation results in the generation of surface —COOH, —CHO and —OH groups on the carbon nanotubes.

Chemical Functionalization Via Radical Initiation Reactions

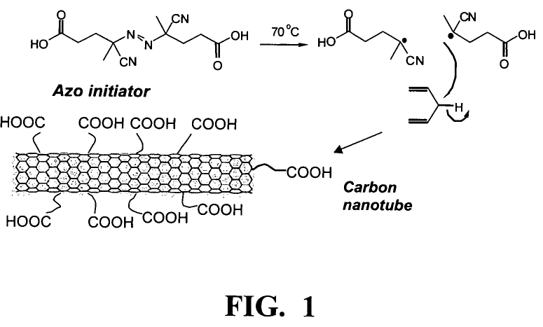

Additionally, carbon nanotubes may be functionalized using a free radical organic initiator, such as azo-initiators. A specific reaction mechanism is shown in FIG. 1 and is illustrative of the general principal. Carbon nanotubes are hollow tubes with a conjugated surface structure (C═C bonds). 2,2′-Azobis(4-cyanovaleric acid) is decomposed at temperatures of about 70° C. to form free radicals. The free radicals attack the double bond (C═C) on carbon nanotubes to form single C—C bonds. This functionalization of the carbon nanotube surface allows for the covalent linking of the CNT with other molecules. Such acid functionalized carbon nanotubes may be dispersed in organic and aqueous solutions. The free radical functionalization of the carbon nanotube surface results in functional groups, including but not limited to, —COOH, —PO₄⁻, —SO₃⁻, —SO₃H, —SH, —NH₂, tertiary amines, quaternized amines, —CHO and/or —OH.

Chemical Functionalization Via Diels-Alder Reactions

The Diels-Alder reaction is a chemical reaction between a conjugated molecule and a C═C bond molecule under certain conditions, as shown below.

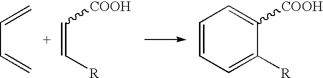

Since carbon nanotubes have a conjugated surface structure, this reaction can be adopted to chemically attach functional groups on the carbon nanotube surface to disperse the carbon nanotubes in organic or aqueous solutions. Chemical functionalization by Diels-Alder reaction results in functional groups on carbon nanotubes, including but not limited to, —COOH, —PO₄—, —SO₃—, —SO₃H, —SH, —NH₂, tertiary amines, quaternized amines, —CHO and/or —OH.

Semiconducting, Singly Dispersed Carbon Nanotubes

Singly dispersed carbon nanotubes may be enriched with semiconducting carbon nanotubes, which may be used to produce a semiconducting carbon nanotube pattern. The enrichment of carbon nanotubes with semiconducting carbon nanotubes may be done using methods known in the art, including, but not limited to, ion-exchange chromatographic separation of DNA-modified, singly dispersed carbon nanotubes, as described in copending and commonly owned WO2004/048286 (the disclosure of which are incorporated by reference herein for all purposes as if fully set forth), in particular Examples 10, 12 and 13. A variety of ion exchange media are suitable for this separation, including anion exchange resins, such as choestyramine, diethyaminoethyl cellulose, diethyaminoethyl Sephadex® (Amersham Biosciences), and diethyaminoethyl Sepharose® ion exchange resins (Amersham Biosciences); as well as cation exchange resins, such as cellulose phosphate, CM cellulose, CM Sephadex® and DOWEX® (Dow Chemical) ion exchange resins, where any strong ion exchange media having been functionalized to contain quaternized polyethyleneimine groups is preferred. Elution of the ion exchange column is typically effected with salt solutions (e.g., NaCl, NH₃SO₄ and NaSCN) according to increasing gradients. Generally the elution solutions are buffered and range in pH from about 5.0 to about 8.0 where about 7.0 is preferred. Methods of adjusting gradients for optimal separation as well as defining the most appropriate ion exchange media are well known in the art.

Ink Jet Ink Compositions

The ink jet ink compositions of the invention comprise an effective amount of physically modified or chemically functionalized, singly dispersed carbon nanotubes in an aqueous carrier medium suitable for ink jet printing. Additionally, a mixture of physically modified and chemically functionalized carbon nanotubes may be used. An effective amount of physically modified or chemically functionalized carbon nanotubes for use in ink jet ink compositions is herein defined as a proportion of from about 0.1% to about 30% by weight, in addition from about 0.1% to about 10% by weight relative to the total weight of the composition. For use in conventional ink jet printers, the ink jet ink compositions of the invention have a surface tension of about 20 to about 70 dynes/cm and a viscosity of about 1 to about 30 centipoise at 25° C. More preferably, the viscosity is about 1 to about 20 centipoise at 25° C. The surface tension and the viscosity of the ink jet ink composition can be readily measured using methods known in the art.

Aqueous carrier media suitable for ink jet printing are disclosed in U.S. Pat. No. 5,085,698 and U.S. Pat. No. 5,272,201, the disclosures of which are incorporated by reference herein for all purposes as if fully set forth. The aqueous carrier medium comprises water or a mixture of water and at least one water-soluble organic solvent. Selection of a suitable mixture depends on requirements of the specific application, such as desired surface tension and viscosity, the drying time of the ink jet ink, and the type of substrate onto which the ink will be printed. Representative examples of water-soluble organic solvents that may be selected include (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl) ether, diethylene glycol mono-methyl (or -ethyl) ether, propylene glycol mono-methyl (or -ethyl) ether, triethylene glycol mono-methyl (or -ethyl) ether and diethylene glycol di-methyl (or -ethyl) ether; (7) nitrogen containing cyclic compounds, such as pyrrolidone, N-methyl-2-pyrrolidone, and 1,3-dimethyl-2-imidazolidinone; and (8) sulfur-containing compounds such as dimethyl sulfoxide and tetramethylene sulfone.

In one embodiment, a mixture of water and a polyhydric alcohol, such as diethylene glycol, is used as the aqueous carrier medium. In the case of a mixture of water and diethylene glycol, the aqueous carrier medium usually contains from about 30% water/70% diethylene glycol to about 95% water/5% diethylene glycol. The preferred ratios are approximately 60% water/40% diethylene glycol to about 95% water/5% diethylene glycol. Percentages are based on the total weight of the aqueous carrier medium.

The ink jet ink compositions of the invention may further comprise a pigment. Useful pigments comprise a wide variety of organic and inorganic pigments, alone or in combination. The pigment particles are sufficiently small to permit free flow of the ink through the ink jet printing device, especially at the ejecting nozzles that usually have a diameter ranging from 10 to 50 micrometers. The particle size also has an influence on the pigment dispersion stability, which is critical throughout the life of the ink. Brownian motion of minute particles will help prevent the particles from settling. It is also desirable to use small particles for maximum color strength. The range of useful pigment particle size is approximately 0.005 to 15 micrometers. Preferably, the pigment particle size is from about 0.005 to about 5 micrometers and most preferably, from about 0.01 to about 0.3 micrometers.

The selected pigment may be used in dry or wet form. For example, pigments are usually manufactured in aqueous media and the resulting pigment is obtained as water wet presscake. In presscake form, the pigment is not aggregated to the extent that it is in dry form. Thus, pigments in water wet presscake form do not require as much deaggregation in the process of preparing the inks from dry pigments. Representative commercial dry and presscake pigments that may be used in practicing the invention are disclosed in U.S. Pat. No. 5,085,698 (the disclosure of which is incorporated by reference herein for all purposes as if fully set forth). The chemically-functionalized or physically modified, singly dispersed carbon nanotubes of the invention may be used as a substitute for carbon black as a black pigment.

Fine particles of metal or metal oxides also may be used in the ink jet ink compositions of the invention. For example, metal and metal oxides are suitable for the preparation of magnetic ink jet inks. Fine particle size oxides, such as silica, alumina, titania, and the like, also may be selected. Furthermore, finely divided metal particles, such as copper, iron, steel, aluminum and alloys, may be selected for appropriate applications.

In the case of organic pigments, the ink may contain up to approximately 30% pigment by weight, but will generally be in the range of approximately 1 to 15%, preferably approximately 1 to 8%, by weight of the total ink composition for most thermal ink jet printing applications. If an inorganic pigment is selected, the ink will tend to contain higher weight percentages of the pigment than with comparable inks employing organic pigment, and may be as high as approximately 50% because inorganic pigments generally have higher specific gravities than the organic pigments.

If the ink jet ink composition comprises a pigment, it further comprises a dispersant for the pigment. The dispersant used to disperse the pigments into the aqueous carrier medium may be a random linear, block, or graft polymer. The block polymer dispersants may be made by conventional free radical techniques using a functionalized chain transfer agent, as described in U.S. Pat. No. 4,032,698, or by living polymerization techniques such as Group Transfer Polymerization, as described in U.S. Pat. No. 4,656,226 (the disclosures of which are incorporated by reference herein for all purposes as if fully set forth). For example, the acrylic block copolymers described in U.S. Pat. No. 5,085,698 (the disclosure of which is incorporated by reference herein for all purposes as if fully set forth) may be used. Additionally, any of the peptide-based diblock or triblock dispersants described by Huang et al. in copending and commonly owned U.S. patent application Ser. No. 10/935642 (WO2005/025505) (the disclosure of which is incorporated by reference herein for all purposes as if fully set forth) may be used. The dispersant may be present in the amount of about 0.1 to about 10%, preferably, about 0.5 to about 3% by weight, based on the total weight of the ink composition.

The ink jet ink compositions of the invention may further comprise a non-aqueous carrier, as described in U.S. Pat. No. 5,772,741 (the disclosure of which is incorporated by reference herein for all purposes as if fully set forth). The non-aqueous carrier is a water insoluble organic solvent such as esters, ketones, ethers, aromatics, hydrocarbons, and alcohols. The non-aqueous carrier may be present in the amount of about 0.5 to about 50%, preferably, about 5 to about 30% by weight, based on the total weight of the ink composition.

C8 to C22 alkanes, alkenes, and alkynes are preferred hydrocarbon solvents and may be straight chained, branched or cyclic. Examples include heptane, octane, dodecane, and isocane. Suitable aromatic solvents include toluene, xylene, naphthalene, anthracene, naphthalene sulphonates, substituted naphthalene sulphonates, phenanthracene and mesitylene. Substituted aromatic solvents, such as cresol, benzyl alcohol, anisole, dimethoxy benzene, methyl anisole and resorcinol may also be used. Suitable ketone solvents include straight chained, branched, or cyclic ketones, such as 2-heptanone, cyclohexanone and methyl cyclohexanone. Suitable ether solvents include aliphatic, aromatic, or aralkyl ethers, such as propylene glycol phenyl ether, dipropylene glycol phenyl ether, ethyleneglycol phenyl ether, and diethylene glycol phenyl ether. Aliphatic, aromatic, and aralkyls esters, such as butyl acetate, hexyl acetate, dimethylesters of adipic acid, dimethylesters of a mixture of C4, C5, and, C6 dibasic acids, methyl octanoate, and methyl benzoate may also be used as the non-aqueous carrier. Straight chained, branched, or cyclic alcohols, such as octanol, cyclohexanol, and dimethylcyclohexanol may also be used to advantage.

If the ink jet ink composition comprises a non-aqueous carrier, it further comprises an emulsifier. The emulsifier is a polymeric or monomeric compound which serves to stabilize the non-aqueous pigment dispersion in the aqueous carrier medium. The emulsifier may be anionic, cationic or non-ionic. The emulsion stabilizer may be present in the amount of about 0.01 to about 10%, preferably, about 0.5 to about 4% by weight, based on the total weight of the ink composition.

The polymeric emulsifier may be a random linear, block, or graft polymer and can be prepared by processes well known to those skilled in the art. Some preferred block polymer emulsifiers for anionic inks are block polymers of methacrylic acid such as benzyl methacrylate//methacrylic acid BZMA//MAA 13//10, and preferred block polymer emulsifiers for cationic inks are block polymers of amino methacrylates such as benzyl methacrylate//dimethylaminoethyl methacrylate BZMA//DMAEMA 10//20. Polymers known in the art as suitable for use in aqueous pigment dispersions, such as those disclosed in previously incorporated U.S. Pat. No. 5,085,698, may also be used as emulsion stabilizers.

The ink jet ink compositions of the invention may further comprise a dye. The dye may be either water-soluble, or if a non-aqueous carrier is used, water insoluble. The dyes are typically used at a concentration of about 0.01% to about 10% by weight, preferably about 0.01% to about 4% by weight, more preferably about 0.05% to about 2% by weight based on the total weight of the ink composition. Examples of suitable dyes are disclosed in previously incorporated U.S. Pat. No. 5,772,741.

Consistent with the requirements for the particular application, various types of aqueous additives can be used to modify the properties of the ink composition. The ink jet ink composition may comprise a surfactant compound. These may be anionic, cationic, nonionic, or amphoteric surfactants. It is known in the art that certain surfactants may be incompatible with certain ink compositions and may destabilize the pigment dispersion. The choice of a specific surfactant is also highly dependent on the type of print medium substrate to be printed. It is expected that one skilled in the art can select the appropriate surfactant for the specific substrate to be used in the particular ink composition. In aqueous inks, the surfactants may be present in the amount of about 0.01% to about 5% and preferably about 0.2% to about 2% by weight, based on the total weight of the ink composition. Co-solvents to improve penetration and pluggage inhibition properties of the ink composition may also be added, and in fact are preferred. Such co-solvents are well known in the prior art. Additionally, biocides may be used in the ink compositions to inhibit growth of microorganisms. Sequestering agents such as ethyl-enediaminetetraacetic acid (EDTA) may also be included to eliminate deleterious effects of heavy metal impurities. Other known additives, such as humectants, viscosity modifiers and other acrylic or non-acrylic polymers may also be added to improve various properties of the ink compositions as desired.

The ink compositions of the present invention may be prepared in the same manner as other aqueous ink compositions, such as described in previously incorporated U.S. Pat. No. 5,272,201 and U.S. Pat. No. 5,772,741.

Printing Carbon Nanotube Patterns

The ink jet ink compositions of the invention may be used to produce a carbon nanotube pattern on a substrate using a conventional ink jet printer, such as an Epson or Hewlett Packard brand desktop ink jet printer. Either continuous ink jet printers or drop-on-demand printers (i.e., piezoelectric or thermal-type) may be used, along with commercially available printheads designed for either industrial or home office applications. The substrate may be any suitable substrate, including, but not limited to, all types of papers (e.g., plain paper, ink jet-ready specialty coated papers, synthetic papers such as Teslin® sheet (PPG Industries), magazine-type glossy papers, and calendered papers), cardboard, textile fabrics, architectural materials (e.g. wallpaper), epoxy/glass laminates, polyimide laminates, organic polymers, glass, ceramics, silicon, silica, metals, and metal oxides.

The ink jet ink composition is applied to the substrate using the ink jet printer and the pattern may be controlled electronically using computer programming. The ink jet ink composition is then dried on the substrate to form the desired carbon nanotube pattern. Typically, the drying is done at a temperature of about 20° C. to about 200° C. The carbon nanotube pattern may be conductive or semiconductive. To form a semiconductive pattern, carbon nanotubes enriched with semiconducting carbon nanotubes, as described above, are used.

The ink jet ink compositions of the invention may be used for conventional printing applications on paper or textile fabrics, wherein the carbon nanotubes serve as a black pigment. The increased surface area of the carbon nanotubes compared to typical pigments may provide an enhanced interaction with the print medium, resulting in increased durability. Additionally, the ink jet ink compositions may be useful for forming a carbon nanotube pattern on a substrate for use in electronic and coating applications. For example, patterned carbon nanotube films may be used as electrical interconnects, electrodes, and wires; in thin film transistors, inductors, capacitors, and resistors; for all types of displays including electroluminescent displays and “electronic paper” displays on flexible substrates; as anti-static coatings; in solar cells; in chemical, biological, or mechanical sensors; and as conductive or semiconducting films on papers, plastics, and textiles.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “mL” means milliliter(s), “L” means liter(s), “μL” means microliter(s), “cm” means centimeter(s), “mm” means millimeter(s), “μm” means micrometer(s), “nm” means nanometer(s), “g” means gram(s), “mg” means milligram(s), “M” means molar concentration, “wt %” means percent by weight, “rpm” means revolutions per minute, “cP” means centipoise, “cSt” means centistokes, “g” means the gravitational constant, “EO” means ethylene oxide, “AFM” means atomic force microscopy, “S” means siemens, and “F” means farad(s).

### Example 1

Ink Jet Ink Composition Containing Chemically Functionalized, Single-Walled Carbon Nanotubes

The purpose of this Example was to demonstrate an ink jet ink composition containing chemically functionalized, single-walled carbon nanotubes. The carbon nanotubes were chemically functionalized by treatment with ammonium persulfate in sulfuric acid.

Preparation of Chemically Functionalized, Single-Walled Carbon Nanotubes

Single-walled carbon nanotubes (0.5 g, HiPCo from Carbon Nanotechnologies Inc., Houston, Tex.) were added to a 50 mL beaker and mixed with 5.0 g of ammonium persulfate (98% from Aldrich, Milwaukee, Wis.) and 15.0 mL of a 1.0 M H₂SO₄ (98%, GR grade from EM Science, Gibbstown, N.J.) aqueous solution by stirring with a magnetic stir plate at room temperature for 48 h. The reaction mixture was transferred into two 15 mL plastic centrifuge tubes and centrifuged at 8,500 rpm for 2 min. The supernatant became clear and was removed. The product was washed with water 5 times using centrifugation to collect the nanotubes. The time required to centrifuge the nanotubes increased with each wash, indicating that the size of the nanotubes was decreasing. The final centrifugation required 60 min. The chemically functionalized carbon nanotubes dispersed in water so well that they were not spun down by centrifuging at 12,500 rpm for 20 min. The final product was near neutral (pH=6.0) and was dried by lyophilization for 24 h. The dried carbon nanotubes were readily dispersed in water.

Preparation of Ink Jet Ink Composition

An aqueous solution of carbon nanotubes (15 wt %) was prepared by mixing 850 mg of deionized water and 150 mg of the dry, chemically functionalized, single-walled carbon nanotubes. An ink jet ink composition containing the chemically functionalized, single-walled carbon nanotubes was prepared by mixing the components given in Table 1.

TABLE 1
Components of Ink Jet Ink Composition

| Component | Concentration, wt % |
|---|---|
| 2-pyrrolidinone | 9.00 |
| Liponics EG-1(EO grafted onto glycerine) | 5.00 |
| Isopropyl alcohol | 2.00 |
| Neopentyl alcohol | 0.2 |
| Carbon nanotube solution (supplied as a 15% | 25.00 |
| weight concentrate) | |
| Proxel GXL (biocide) | 0.2 |
| Water | 58.60 |
| Total | 100 |

The density, the absolute viscosity, and the kinematic viscosity of the ink jet ink composition were measured and found to be 1.032 g/mL, 2.37 cP, and 2.30 cSt, respectively. The surface tension of the ink jet ink composition was 47.5 dynes/cm.

### Example 2

Ink Jet Ink Composition Containing Physically Modified, Single-Walled Carbon Nanotubes

The purpose of this Example was to demonstrate an ink jet ink composition containing physically modified, single-walled carbon nanotubes. The carbon nanotubes were physically modified by treatment with DNA.

Preparation of DNA-Dispersed Carbon Nanotubes

DNA-dispersed carbon nanotubes were prepared as described in US2004/0132072. Single-walled carbon nanotubes, made by the HiPCO process, either purified or unpurified, were purchased from Carbon Nanotechnologies Inc. (Houston, Tex.). The materials were used as received without further modification. The single-stranded DNA (ssDNA) oligonucleotide (C/T)30, given as SEQ ID NO:1, was purchased from Integrated DNA Technologies, INC (Coralville, Iowa). (C/T)30 is an oligonucleotide with a length of 30 bases consisting of a random mix of cytosine and thymine. In a typical experiment, 10 mg of the single-walled carbon nanotubes was suspended in 10 mL of 1×SSC buffer (0.15 M NaCl, 0.015 M sodium citrate), then sonicated for 2 min with a TORBEO 130-Watt Ultrasonic Processor (Cole-Parmer Instrument Company, Vernon Hills, Ill.). The (C/T)30 oligonucleotide was dissolved in H₂O to give a final concentration of 10 mg/mL. Then, 50 μL of the carbon nanotube suspension and 5 μL of 10 mg/mL oligonucleotide solution were added to 200 μL of H₂O to give a final volume of 255 μL. The mixture was sonicated for 3 min, followed by 90 min of centrifugation at 16,000× g (Biofuge fresco, Kendro Laoratory Products, Newtown, Conn.). The carbon nanotubes were dried by lyophilization for 24 h.

The dimensions of the DNA-dispersed, single-walled carbon nanotubes were determined using atomic force microscopy (AFM). The diameter of the DNA-dispersed carbon nanotubes was in the range of 0.8 to 1.2 nm with an average of 1.0 nm. The length of the carbon nanotubes was in the range of 100 nm to 1.0 μm, with an average of 200 nm.

Preparation of Ink Jet Ink Composition

The ink jet ink composition was prepared as described in Example 1 using the DNA-dispersed carbon nanotubes. An aqueous solution of carbon nanotubes (15 wt %) was prepared by mixing 850 mg of deionized water and 150 mg of the dry, DNA-dispersed carbon nanotubes. This ink jet ink composition is expected to have properties similar to those of the ink jet ink composition described in Example 1.

### Example 3

Conductive, Chemically Functionalized Carbon Nanotube Film on a Glass Substrate

The purpose of this Example was to demonstrate the preparation of a conductive carbon nanotube film on a glass substrate using an ink jet ink composition containing chemically functionalized, single-walled carbon nanotubes, and to measure the conductivity of the film.

A 25×75 mm glass slide was cleaned with methanol, acetone, and water, and dried with nitrogen gas. Scotch tape (manufactured by 3M) was used to build a 10×10 mm square “dam” on the glass slide. The ink jet ink composition described in Example 1 was added drop-wise to the “dam” using a glass pipette. The composition was dried on the glass slide by evaporation in air at room temperature. This process was repeated 6 times, and then the film was dried in air for 2 h, followed by drying in an oven at 100° C. for 1 h.

The conductivity of the dried carbon nanotube film was calculated from measurements of its sheet resistance and thickness. Sheet resistance was measured using the 4-point probe method of van der Pauw (Van der Pauw, L. J. Philips Technical Review 1958/1959, 26(8), 220-224). Flash-Dry™ conductive silver paint from SPI (Structure Probe, Inc., West Chester, Pa.) was used to add 1 mm-diameter low-resistance electrical contacts to each corner of the rectangular CNT film, ensuring that contact resistance between the measuring probes and the CNT film was negligible. The sheet resistance determined was 2.9×10⁵ ohms per square. The film thickness was measured using a Model P15 KLA-Tencor profilometer (KLA-Tencor, San Jose, Calif.) with a low-force sensor option. Five thickness measurements were made at various points in the film and were averaged to give a thickness of 65 μm. From these data the conductivity of the film was calculated to be 5.3×10⁻⁴ S/cm.

### Example 4

Conductive, Physically Modified Carbon Nanotube Film on a Silicon Substrate

The purpose of this Example was to demonstrate the preparation of a conductive carbon nanotube film on a silicon substrate using an ink jet ink composition containing physically modified, single-walled carbon nanotubes, and to measure the conductivity of the film.

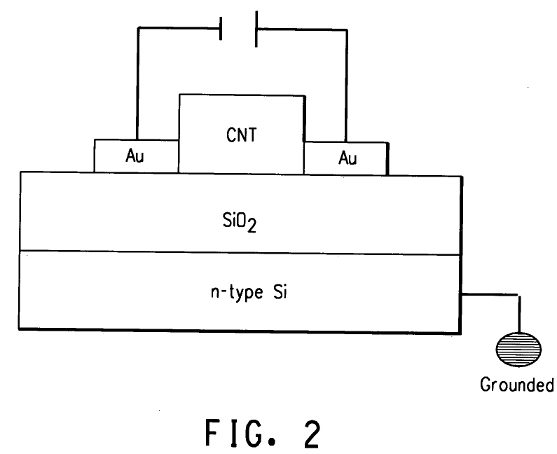

The substrate used was a heavily doped n-type silicon wafer (Silicon Valley Microelectronics) with 200 nm thermal oxide (SiO₂) on the top surface, which acts as a dielectric layer with a capacitance per unit area of 1.73×10⁻⁸ F/cm². The top surface also contained photolithography-patterned gold electrodes (as shown in FIG. 2); the channel length and the channel width between the two gold electrodes were 5 μm and 50 μm, respectively. The etched heavily doped n-type silicon on the back surface served as a gate electrode. The wafers were cleaned through subsequent washing with acetone, isopropanol, and deionized water, blown dry with N₂ gas, and cleaned in an oxygen plasma for 6 min. The carbon nanotube dispersion of Example 2 was spin or drop cast on top of the SiO₂ layer containing the gold electrodes.

The conductivity of the deposited carbon nanotube film was measured by a two-probe method. During the measurement, the gate electrode was grounded. A series of voltages were applied between the two gold electrodes and the current flow between the two gold electrodes was measured. From the data, the conductivity of the thin films was calculated to be approximately 1×10⁻⁶ S/cm. This measurement did not take into account the contact resistance between the nanotubes and the gold electrodes.

What is claimed is:

1. An ink jet ink composition comprising:
(a) an aqueous carrier medium suitable for ink jet printing; and
(b) chemically functionalized or physically modified, singly dispersed carbon nanotubes, wherein the carbon nanotubes have an average outer diameter of less than or equal to about 10 nanometers and a length between about 100 nanometers and about 1 micrometer.

2. The ink jet ink composition of claim 1, wherein the carbon nanotubes are chemically functionalized.

3. The ink jet ink composition of claim 2, wherein the chemically functionalized carbon nanotubes are produced by a process selected from the group consisting of oxidation, radical initiation reactions, and Diels-Alder reactions.

4. The ink jet ink composition of claim 1, wherein the chemically functionalized carbon nanotubes comprise functional groups selected from the group consisting of —COOH, —PO₄⁻, —SO₃⁻, —SO₃H, —SH, NH₂, tertiary amines, quaternized amines, —CHO and —OH.

5. The ink jet ink composition of claim 1, wherein the carbon nanotubes are physically modified.

6. The ink jet ink composition of claim 5, wherein the physically modified carbon nanotubes are associated with a modifying agent.

7. The ink jet ink composition of claim 6, wherein the modifying agent is selected from the group consisting of organic polymers, surfactants and biopolymers.

8. The ink jet ink composition of claim 7, wherein the modifying agent is an organic polymer selected from the group consisting of polyamines, anionic polymers, and cationic polymers.

9. An ink jet ink composition of claim 7 wherein the modifying agent is a biopolymer selected from the group consisting of peptides, proteins, nucleic acids and peptide nucleic acids.

10. The ink jet ink composition of claim 1, wherein the carbon nanotubes are either single-walled or multi-walled.

11. The ink jet ink composition of claim 1, wherein the ink jet ink composition is conductive after being printed on a substrate.

12. The ink jet ink composition of claim 1, wherein the carbon nanotubes are enriched with semiconducting carbon nanotubes and the ink jet ink composition is semiconductive after being printed on a substrate.

13. The ink jet ink composition of claim 1, wherein the composition comprises from about 0.1% to about 30% of the carbon nanotubes by weight.

14. The ink jet ink composition of claim 1, wherein the composition comprises from about 0.1% to about 10% of the carbon nanotubes by weight.

15. The ink jet ink composition of claim 1, wherein the composition has a surface tension of about 20 to about 70 dynes/cm and a viscosity of about 1 to about 30 centipoise at 25° C.

16. The ink jet ink composition of claim 2, wherein the carbon nanotubes are produced by a process comprising the steps of:
(a) providing a population of undispersed carbon nanotubes in solution;
(b) contacting the carbon nanotubes of (a) with a radical generating agent in the presence of an acid for a time sufficient to permit the carbon nanotubes to disperse; and
(c) optionally recovering the carbon nanotubes.

17. A method of producing an ink jet ink composition comprising chemically functionalized and singly dispersed carbon nanotubes, comprising the steps of:
(a) providing a population of undispersed carbon nanotubes in solution;
(b) contacting the carbon nanotubes of (a) with a radical generating agent in the presence of an acid for a time sufficient to permit the carbon nanotubes to disperse; and
(c) mixing the dispersed carbon nanotubes of (b) with an aqueous carrier medium suitable for ink jet printing.

18. A method of producing a carbon nanotube pattern on a substrate comprising the steps of:
(a) providing an ink jet ink composition comprising (i) an aqueous carrier medium suitable for ink jet printing and (ii) chemically functionalized or physically modified, and singly dispersed carbon nanotubes, wherein the carbon nanotubes have a mean outer diameter of less than or equal to about 10 nanometers and a length between about 100 nanometers and about 1 micrometer;
(b) printing a pattern of the ink jet ink composition of (a) on the substrate using an ink jet printer, and
(c) drying the ink jet ink composition on the substrate of (b) to form the carbon nanotube pattern.

19. The method of claim 18, wherein the carbon nanotube pattern is conductive.

20. The method of claim 18, wherein the carbon nanotubes are enriched with semi-conducting carbon nanotubes and the carbon nanotube pattern is semiconductive.

21. The method of claim 18, wherein the drying of step (c) is done at a temperature of about 20° C. to about 200° C.

22. The method of claim 18, wherein the substrate is selected from the group consisting of papers, cardboard, textile fabrics, architectural materials, epoxy/glass laminates, polyimide laminates, organic polymers, glass, ceramics, silicon, silica, metals, and metal oxides.


SEQUENCE LISTING (1 sequence)

SEQ ID NO: 1 - DNA, 30 bp, Artificial Sequence
  Random c and t oligonucleotide
nnnnnnnnnnnnnnnnnnnnnnnnnnnnnn